(19) United States
(12) Patent Application Publication
(10) Pub. No.: US 2012/0096049 A1
(43) Pub. Date: Apr. 19, 2012

(54) WORKGROUP TIME-TRACKING

(75) Inventor: Christopher Reinke, Watertown, NY (US)

(73) Assignee: salesforce.com, inc., San Francisco, CA (US)

(21) Appl. No.: 13/048,705

(22) Filed: Mar. 15, 2011

Related U.S. Application Data
(60) Provisional application No. 61/393,627, filed on Oct. 15, 2010.

(51) Int. Cl. G06F 17/30; G06F 7/00

(52) U.S. Cl. 707/803; 707/E17.055

(57) ABSTRACT

Disclosed are systems, methods, and computer readable media for creating, and using time tracking data objects which can be used for applications such as tracking efforts expended by a group of users on tasks to which they have been assigned. In one embodiment, when a record is saved, it is determined if an attribute of the record has changed. Examples of attributes of a record may be the owner of a record, the status of a record, a case number, the group member's name, or the workgroup a member to whom the record belongs. When an attribute of the record has changed and the record has an open status, a time tracking data object is created. The time tracking data object may contain multiple fields storing information regarding attributes of the record. The fields may store information such as a start time, duration time, and status of the time tracking data object.

### PRIORITY AND RELATED APPLICATION DATA

This application claims priority to co-pending and commonly assigned U.S. Provisional Patent Application No. 61/393,627, titled WORKGROUP TIME-TRACKING, by Christopher Reinke, filed on Oct. 15, 2010 (Attorney Docket No. SLFCP019P/476PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to on-demand services provided over a data network such as the Internet, and more specifically to methods and techniques of storing records in a database system.

### BACKGROUND

Organizations typically employ many different types of software and computing technologies to meet their computing needs. However, installing and maintaining software on an organization's own computer systems may involve one or more drawbacks. For example, when software must be installed on computer systems within the organization, the installation process often requires significant time commitments, since organization personnel may need to separately access each computer. Once installed, the maintenance of such software typically requires significant additional resources. Each installation of the software may need to be separately monitored, upgraded, and/or maintained. Further, organization personnel may need to protect each installed piece of software against viruses and other malevolent code. Given the difficulties in updating and maintaining software installed on many different computer systems, it is common for software to become outdated. Also, the organization will likely need to ensure that the various software programs installed on each computer system are compatible. Compatibility problems are compounded by frequent upgrading, which may result in different versions of the same software being used at different computer systems in the same organization.

Accordingly, organizations increasingly prefer to use on-demand services accessible via the Internet rather than software installed on in-house computer systems. On-demand services, often termed “cloud computing” services, take advantage of increased network speeds and decreased network latency to provide shared resources, software, and information to computers and other devices upon request. Cloud computing typically involves over-the-Internet provision of dynamically scalable and often virtualized resources. Technological details can be abstracted from the users, who no longer have need for expertise in, or control over, the technology infrastructure “in the cloud” that supports them.

### BRIEF DESCRIPTION OF THE DRAWINGS

The included drawings are for illustrative purposes and serve only to provide examples of possible structures and process steps for the disclosed inventive systems and methods for providing time tracking data objects. These drawings in no way limit any changes in form and detail that may be made to embodiments by one skilled in the art without departing from the spirit and scope of the disclosure.

FIG. 1 is a flowchart showing a process 100 for creating a time tracking data object, in accordance with one embodiment.

FIG. 2 is a flowchart showing a process 200 for creating a time tracking data object after saving a record in a database system, in accordance with one embodiment.

FIG. 3 is a flowchart showing a process 300 for creating a time tracking data object to track the history of efforts expended by members of a designated workgroup upon a case, in accordance with one embodiment.

FIG. 4A shows a system diagram 400 illustrating architectural components of an on-demand service environment, in accordance with one embodiment.

FIG. 4B shows a system diagram further illustrating architectural components of an on-demand service environment, in accordance with one embodiment.

FIG. 5 shows a system diagram 510 illustrating the architecture of a multitenant database environment, in accordance with one embodiment.

FIG. 6 shows a system diagram 510 further illustrating the architecture of a multitenant database environment, in accordance with one embodiment.

FIG. 7 is an example of an image 700 of a user interface displaying a time tracking data object generated in accordance with one embodiment of process 100.

FIG. 8 is an example of an image 800 of a user interface displaying multiple time tracking data objects generated in accordance with one embodiment of process 300 and filtered according to a case identification number.

FIG. 9 is an example of an image 900 of a user interface displaying multiple time tracking data objects generated in accordance with one embodiment of process 300 and filtered according to workgroup.

FIG. 10 is an example of an image 1000 of a user interface displaying multiple time tracking data objects generated in accordance with one embodiment of process 300 and filtered according to workgroup member.

### DETAILED DESCRIPTION

Examples of systems, apparatus, and methods according to the disclosed embodiments are described in this section. These examples are being provided solely to add context and aid in the understanding of the disclosed embodiments. It will thus be apparent to one skilled in the art that implementations may be practiced without some or all of these specific details. In other instances, well known process/method steps have not been described in detail in order to avoid unnecessarily obscuring embodiments. Other applications are possible, such that the following examples should not be taken as definitive or limiting either in scope or setting.

In the following detailed description, references are made to the accompanying drawings, which form a part of the description and in which are shown, by way of illustration, specific embodiments. Although these embodiments are described in sufficient detail to enable one skilled in the art to practice the disclosed implementations, it is understood that these examples are not limiting, such that other embodiments may be used and changes may be made without departing from their spirit and scope. For example, the blocks of methods shown and described herein are not necessarily performed in the order indicated. It should also be understood that the methods may include more or fewer blocks than are indicated. In some implementations, blocks described herein as separate blocks may be combined. Conversely, what may be described herein as a single block may be implemented in multiple blocks.

Conventional methods of tracking efforts expended by users often provide insufficient historical information of efforts expended by those users. In some conventional systems, a user only has access to current information regarding the tasks assigned to other users of the system. A historical account of tasks a user has previously completed would not be available to the user in such systems.

In one conventional scenario, a user supervises a group of other users. If the supervisor wishes to track the efforts expended by his or her team of workers, the supervisor must expend a considerable amount of effort to follow members of his or her team and the current tasks that they are assigned. If a user changes teams, i.e., to work under a new supervisor, the new supervisor does not have the ability to report on historical efforts performed by the user unless the previous efforts of the user are reported to him or her. Furthermore, conventional tracking techniques do not maintain detailed information about the task the user was performing, such as the amount of time the task was in a specific status. Limitations such as these impede the ability of supervisors to make detailed analyses of efforts expended by their workers.

The disclosed implementations provide the ability to generate reports including information detailing efforts expended by a group of users on tasks to which they have been assigned. Implementations of the disclosed methods and systems also allow a supervisor to view a detailed history of efforts expended by users under his or her supervision. In this way, reports can be generated, including detailed information about cases assigned to his or her team without having to extensively modify the reports. Furthermore, the reports may include historical information regarding past efforts expended by users under his or her supervision or under another user's supervision. These reports can be generated without having to perform extensive customization or modification of the reports. Such reports may be presented on a graphical user interface of a display device.

In one example, a manager may be responsible for the supervision of a group of employees. The employees may be assigned a variety of tasks. For example, an employee may be responsible for working on a case for a client. The case may involve a specific issue related to the client that requires resolution by the employee. The manager may wish to monitor how many cases are assigned to the employees under the manager's supervision and how those employees are expending time and effort on cases to which they are assigned. The manager may utilize methods disclosed herein to generate a report that only includes information relevant to cases currently assigned to employees under the manager's supervision. The report may provide information regarding cases assigned to the entire group of employees under the manager's supervision. The report may also provide information regarding all cases assigned to a particular employee. The report may additionally provide a detailed history of each case assigned to an employee. The case history may include information such as who was initially assigned the case, who else has worked on the case and how long the case has been in a particular status. Thus, the report may provide the manager with comprehensive information regarding efforts expended by a group of employees under the manager's supervision.

If an employee under the manager's supervision transfers to another team and is now under the supervision of another manager, the history of efforts expended by the employee is not lost. If the employee's new manager wishes to generate a report, the report may also include information regarding efforts expended by the employee while previously assigned to the first manager's team. Thus, the new manager is provided with detailed information regarding the past efforts of employee's under his or her supervision.

These and other embodiments may be implemented by various types of hardware, software, firmware, etc. For example, some embodiments may be implemented, at least in part, by machine-readable media that include program instructions, state information, etc., for performing various services and operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store program instructions, such as read-only memory devices (“ROM”) and random access memory (“RAM”). These and other features and benefits of the disclosed embodiments will be described in more detail below with reference to the associated drawings.

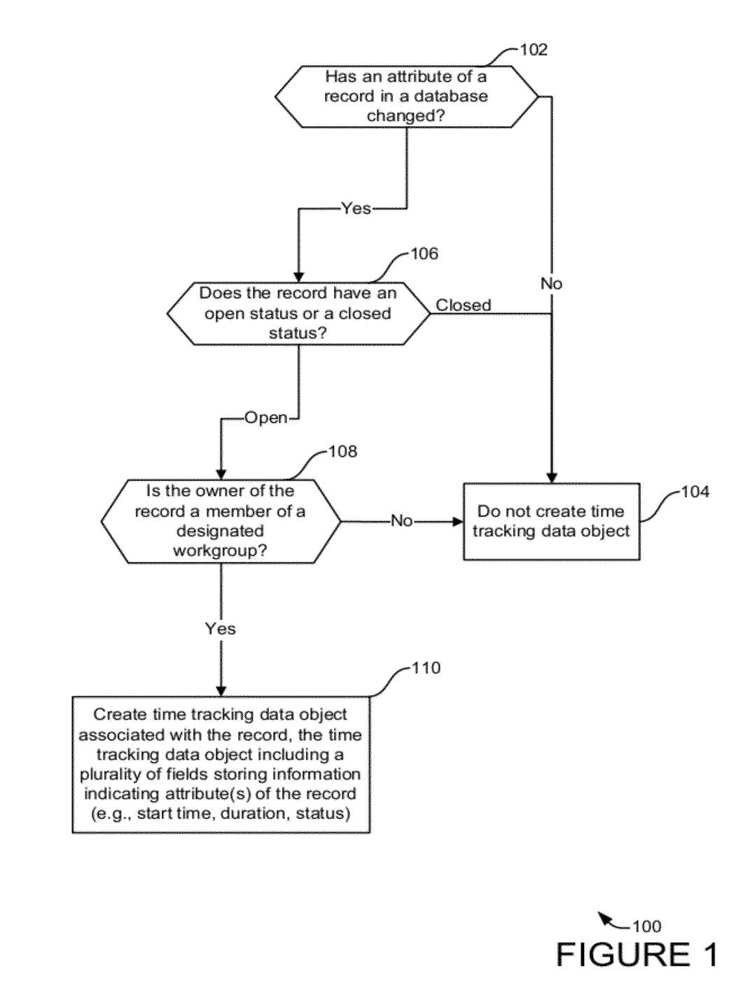

FIG. 1 is a flowchart showing a process 100 for creating a time tracking data object, in accordance with one embodiment. As discussed in greater detail below, a time tracking data object may be a data object stored in a database system. The time tracking data object may track several features associated with a record. The term “record” generally refers to a data entity, such as an instance of a data object created by a user of the database service, for example, about a particular (actual or potential) business relationship or project. The data object can have a data structure defined by the database service (a standard object) or defined by a subscriber (custom object). For example, a record can be for a business partner or potential business partner (e.g. a client, vendor, distributor, etc.) of the user, and can include an entire company, subsidiaries, or contacts at the company. As another example, a record can be a project that the user is working on, such as an opportunity (e.g. a possible sale) with an existing partner, or a project that the user is trying to get. A record has data fields that are defined by the structure of the object (e.g. fields of certain data types and purposes). A record can also have custom fields defined by a user. A field can be another record or include links thereto, thereby providing a parent-child relationship between the records.

The database system in which the record and time tracking data object reside may be a multi-tenant database system. The term “multi-tenant database system” can refer to those systems in which various elements of hardware and software of the database system may be shared by one or more customers. For example, a given application server may simultaneously process requests for a great number of customers, and a given database table may store rows for a potentially much greater number of customers. It will be appreciated that the record and time tracking data object associated with the record may reside in either the same or separate database systems.

Returning to FIG. 1, process 100 begins at block 102, where it is determined whether or not an attribute of a record in a database has changed. As discussed in greater detail below, an attribute of a record may be, for example, an owner of the record or a status of the record. Thus, the determination that an attribute of a record has changed may occur, for example, if there is a change in ownership of the record or a change in status of the record. In various implementations, if it is determined that no attribute associated with a record in a database has changed, then process 100 proceeds to block 104 in which no time tracking data object is created. At this point in process 100, the system may await another determination of whether or not an attribute of a record in a database has changed. Thus, in particular implementations, if no time tracking data object is created, process 100 may repeat by returning to block 102. In block 102, if it is determined that an attribute of a record in a database has changed, then process 100 may proceed to block 106.

In FIG. 1, in block 106, it is determined whether or not the record has an open status or a closed status. In various implementations, if the record has a closed status, it can be presumed that the record is not being worked on by a user, such as a member of a workgroup. Thus, in accordance with process 100, if at block 106 it is determined that the record has a closed status, a time tracking data object is not created in block 104. Moreover, at block 104, it may be determined whether additional time tracking data objects associated the record already exist. If so, such existing time tracking data objects can be updated to indicate a closed status. Thus, according to various implementations, at block 104, all time tracking data objects associated with the record can be updated to indicate a closed status in response to block 106.

Returning to block 106, according to some implementations, if the record has an open status, it can be presumed that a member of a workgroup may wish to access the record. If at block 106 it is determined that the record has an open status, process 100 proceeds to block 108.

In FIG. 1, in block 108, it is determined whether or not the owner of the record is a member of a designated workgroup. An “owner” of a record may refer to a user associated with the record. For example, as discussed in greater detail below, an owner of a record may be an employee assigned to a particular case. A “workgroup” is generally a collection of users, such as employees. In some aspects, the workgroup may be defined as users with a same or similar attribute, or by membership. In some implementations, a workgroup may, for example, be a group such as “Helpdesk.” The workgroup “Helpdesk” may consist of a group of employees or workers responsible for helping solve general technological problems associated with a particular system. Thus, any employee or worker responsible for resolving those types of issues would be considered a member of the workgroup “Helpdesk.”

In various implementations, a workgroup member may also be a queue. A queue may be a data structure that serves as a flexible mechanism for managing records. A queue may include a group of records that are related to each other. By assigning records to a queue, related records may be organized, grouped, and handled together. For example, a queue may exist for a particular topic or client, such as “network server 123.” The queue may include a group of records associated with “network server 123.” Such a group of records may contain information regarding technological issues or problems that network server 123 may have had in the past, and what issues may still need to be resolved. The group of records in the queue may be sorted chronologically, by number, or even by a level of difficulty indicated by a supervisor. The queue associated with “network server 123” may be a member of the workgroup “Helpdesk.” Accordingly, using a queue to group records allows a user of the disclosed system to track groups of related records when tracking a workgroup without expending additional effort.

In some implementations, a designated workgroup may refer to a workgroup that a supervisor wishes to observe. If the owner of the record is not a member of a designated workgroup, then it may be safe to assume that efforts expended by the owner upon the record are not relevant to the overall efforts expended by the designated workgroup. However, if the owner of the record is a member of a designated workgroup, then it may be safe to assume that the efforts expended by the owner upon the record are relevant to the overall efforts expended by the designated workgroup.

Returning to FIG. 1, if it is determined in block 108 that the owner of the record is not a member of a designated workgroup, a time tracking data object is not created in block 104. Moreover, as discussed above with respect to block 106, at block 104, process 100 may update existing time tracking data objects to indicate a closed status in response to the determination of block 108. However, if the owner of the record is a member of a designated workgroup, then process 100 may proceed to create a time tracking data object, as explained below. Thus, by creating a time tracking data object when the owner of the record is a member of a designated workgroup, efforts expended by specific workgroup members upon the record may be tracked while efforts expended by non-members are not tracked.

In FIG. 1, in block 110, a time tracking data object associated with the record is created. The time tracking data object may include several fields storing information indicating attributes of the record. Thus, a time tracking data object may store and track data representing information about various attributes associated with a record over a certain period of time. As discussed in greater detail below, examples of such information may include the creation time of the time tracking data object, the duration of time that the time tracking data object tracks data associated with the record, and the status of the record during that duration of time.

In various implementations, a time tracking data object may be created in response to the creation of a workgroup or a workgroup member. For example, a message indicating that a workgroup member has been created and that the workgroup member is a member of a designated workgroup may cause time tracking data objects to be created for all open cases associated with the workgroup member. The same may be true for the creation of a new workgroup. For example, the message may indicate that a new workgroup has been created. In response to this message, time tracking data objects associated with all open cases associated with the workgroup may be created. In some implementations, deletion or removal of a workgroup member or workgroup may cause all time tracking data objects associated with the workgroup member or workgroup having an open status to be updated to a closed status.

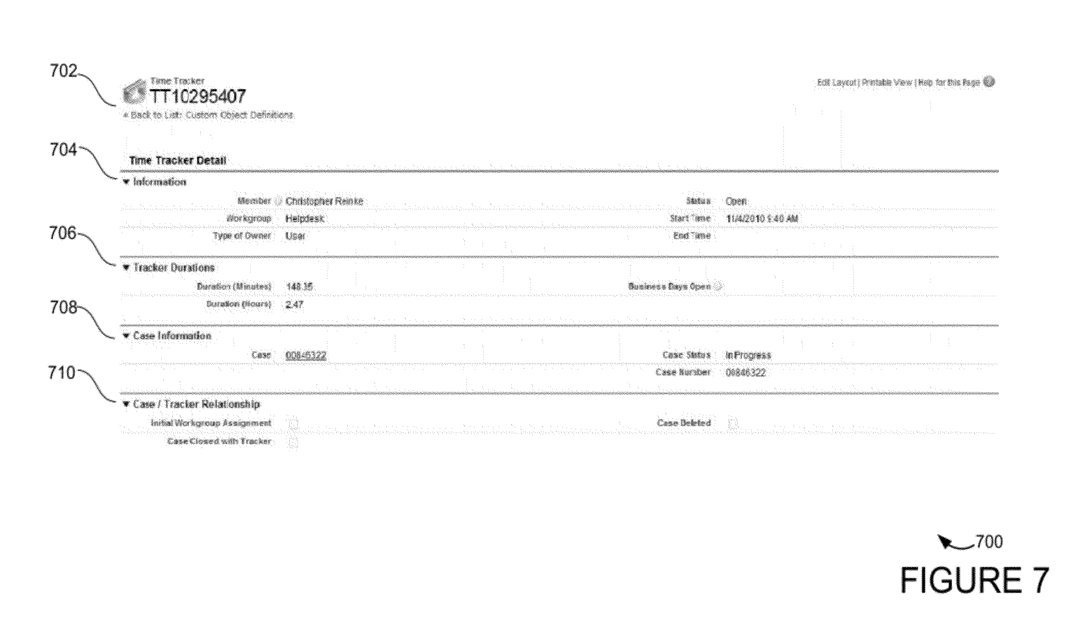

FIG. 7 is an example of an image 700 of a user interface displaying a time tracking data object generated in accordance with one embodiment of process 100. Image 700 may be displayed to a user in response to the creation of a time tracking data object in block 110, or upon request by a user of the presently disclosed system. Image 700 may be displayed to a user via a graphical user interface displayed on a display of a computing device. In one example, image 700 of the time tracking data object may include data fields 702, 704, 706, 708, and 710, which can be stored on a storage medium such as a database as fields of the time tracking data object.

Data field 702 may display information regarding the identification of the time tracking data object. For example, data field 702 may contain an identification number specific to a time tracking data object. The identification number of the time tracking data object may serve as a basis for locating the time tracking data object within the database system in which it resides.

Data field 704 may display general information regarding the record associated with the time tracking data object. For example, data field 704 may display the name of the owner of the record, the workgroup the owner belongs to, what type of owner he or she is, the status of the record associated with the time tracking data object, and the time at which the time tracking data object started and finished tracking information.

Data field 706 may display information regarding the duration of the time tracking data object. For example, data field 706 may display how long the time tracking data object was recording information associated with a record. The length of time may be displayed in minutes, hours, days, or any other unit of time.

Data field 708 may display information regarding the identity of the record associated with the time tracking data object. As discussed in greater detail below, the record may be a case. Thus, data field 708 may display the case identification number and the status of the case.

Data field 710 may display information regarding the relationship between a record and a time tracking data object. For example, data field 710 may display the initial workgroup assignment of a case, which time tracking data object a case was closed with, and whether or not a case has been deleted.

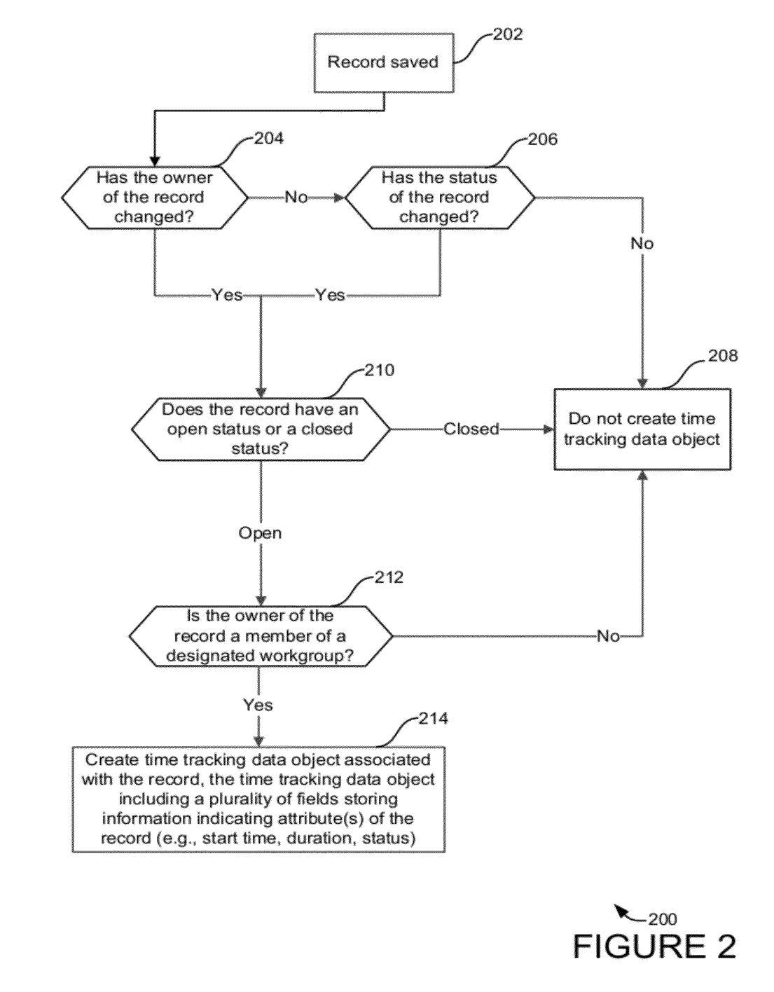

FIG. 2 is a flowchart of a process 200 for creating a time tracking data object after saving a record in a database system, in accordance with one embodiment. In FIG. 2, process 200 begins in block 202, in which a record may be saved in a database system. Saving a record may refer to storing values in fields of the record on a storage medium of the database system. In block 204, responsive to record creation at block 202, it is determined whether or not the owner of a record has changed. For example, the ownership of a record may change if ownership has been transferred to someone other than the current owner of the record. Ownership of a record may be transferred by a manager of a workgroup or other entity with requisite authority. If a change in ownership of the record has occurred, process 200 proceeds to determine if the record has an open status or a closed status, as discussed in greater detail below. However, if no change in ownership of the record has occurred, process 200 proceeds to block 206.

In FIG. 2, in block 206, it is determined if the status of the record has changed. In some implementations, the status of the record may indicate whether or not someone is working on the record or if the record is currently open or closed, by way of example. According to various implementations, if it is determined that the status of the record has not changed, then process 200 may proceed to block 208 in which a time tracking data object is not created. However, if it is determined that a change in the status of the record has occurred, process 200 may proceed to block 210.

In FIG. 2, in block 210, it is determined if the record has an open status or a closed status, as explained above at block 106. In some implementations, if the record has a closed status, process 200 proceeds to block 208 and no time tracking data object is created. Additionally, as discussed above at block 106, at block 208, process 200 may include updating existing time tracking data objects to indicate a closed status in response to either block 210 or block 206. However, according to various implementations, if the record has an open status, process 200 proceeds to block 212.

In FIG. 2, in block 212, it is determined if the owner of the record is a member of a designated workgroup, as explained above at block 108. If it is determined that the owner of the record is not a member of a designated workgroup, process 200 proceeds to block 208, and a time tracking data object is not created. However, if it is determined that the owner of the record is a member of a designated workgroup, process 200 may proceed to block 214 and create a time tracking data object, as described above at block 110.

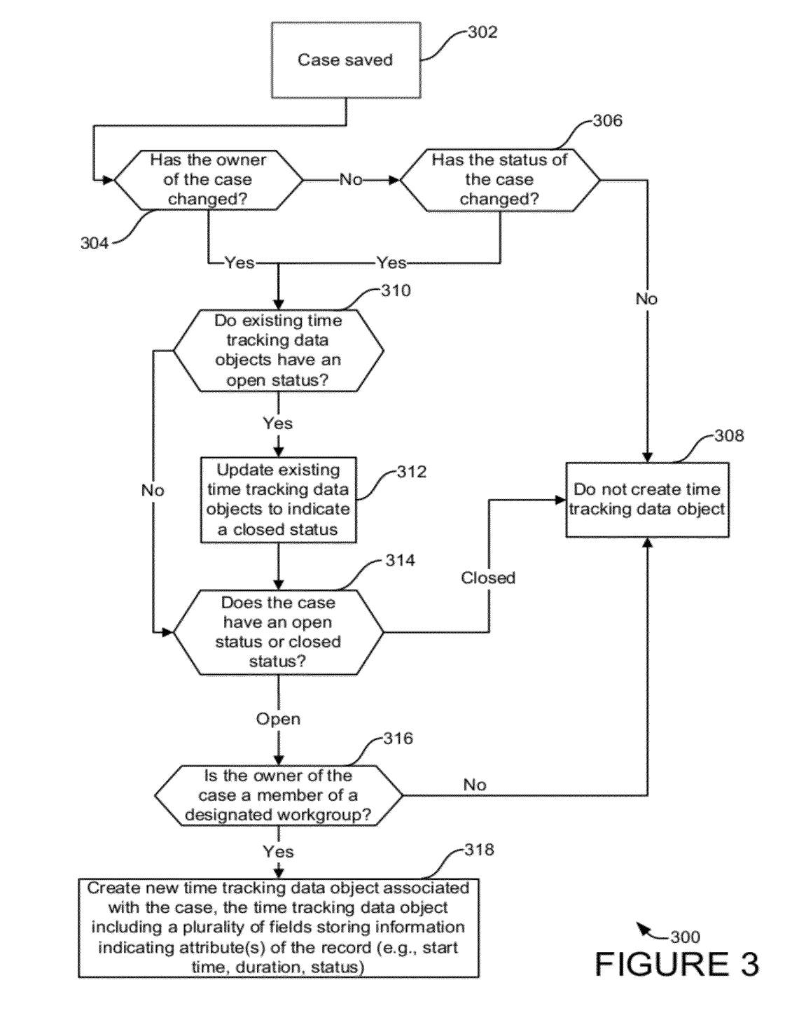

FIG. 3 is a flowchart of a process 300 for creating a time tracking data object to track the history of efforts expended by members of a designated workgroup upon a case, in accordance with one embodiment. In FIG. 3, process 300 begins at block 302, where a case may be saved. In some implementations, a case may be a record associated with a client. For example, the case may contain information regarding a specific issue related to a client that needs resolution. The case may have information associated with it, such as a case identification number, a client code, and a matter code.

In FIG. 3, in block 304, responsive to the saving of a case at block 302, it is determined whether or not the owner of the case has changed. For example, the owner of a case may be a workgroup member who is currently responsible for the case. In some implementations, there may only be one owner of a case at a given moment in time. If the case has been transferred between workgroups or workgroup members, a change in the ownership of the case may occur. If the owner of the case changes, process 300 may proceed to block 310. However, if the owner of the case does not change, then process 300 may proceed to block 306.

In FIG. 3, in block 306, it is determined whether or not the status of the case has changed. In various implementations, the status of the case may change through actions of the owner of the case. For example, the owner of the case may change the status of a case from a status of “active” to a status of “on hold” if work on the case is temporarily suspended. Moreover, the owner of the case may resolve an issue that is the subject of the case and consequently change the status of the case from an open status to a closed status. This change in status may indicate that the case requires no more work by a workgroup member. Accordingly, if the status of the case has not changed, then process 300 may proceed to block 308, where no time tracking data object is created and process 300 may terminate. However, if the status of the case has changed, process 300 may proceed to block 310.

In FIG. 3, in block 310, it is determined if one or more existing time tracking data objects associated with the case have an open status. Thus, according to some implementations, several time tracking data objects may have been previously created and associated with a case. Moreover, it may be possible that at least one of these existing time tracking data objects associated with the case has an open status and may be tracking data associated with the case. If such existing time tracking data objects having an open status are found, process 300 may proceed to block 312, where the existing time tracking data objects are updated to indicate a closed status. When in the closed status, the existing time tracking data objects no longer track data associated with the case. Consequently, after the existing time tracking data objects have been updated to a closed status, a further time tracking data object created later in process 300 will be the only time tracking data object with an open status, that is, actively tracking data associated with the case. Accordingly, duplicative tracking of data can be avoided. If existing time tracking data objects having an open status are not found in block 312, process 300 may proceed to block 314.

In FIG. 3, in block 314, it is determined if the case has an open status or a closed status. In some implementations, if the case has a closed status, the case may be considered resolved and no further work may be required by workgroup members. Accordingly, if the case has a closed status, process 300 may proceed to block 308 where a time tracking data object is not created. However, if the case has an open status, the case might not yet be resolved and members of a designated workgroup may still need to work on the case. Thus, according to various implementations, if the case has an open status, process 300 may proceed to block 316.

In FIG. 3, in block 316, it is determined if the owner of the record is a member of a designated workgroup, as explained above at block 108. If at block 316 it is determined that the owner of the case is not a member of a designated workgroup, process 300 may proceed to block 308 where no time tracking data object is created. However, if at block 316 it is determined that the owner of the case is a member of the designated workgroup, then process 300 may proceed to block 318.

In FIG. 3, in block 318, a time tracking data object associated with the case is created. As explained above with respect to FIG. 7, the time tracking data object may include several data fields storing information regarding attributes of the case. The time tracking data object may continue to track relevant information about the case as long as it has an open status.

In various implementations, if a case is deleted, time tracking data objects associated with the case may be updated to indicate the deletion of the case. For example, if a case is deleted, it may be determined if there are any existing time tracking data objects associated with the case. If existing time tracking data objects associated with the case are found, they may be updated to indicate a “deleted” status. Accordingly, the existing time tracking data objects may indicate that a case has been deleted. Such an indication allows a user to determine which time tracking data object a case was closed with.

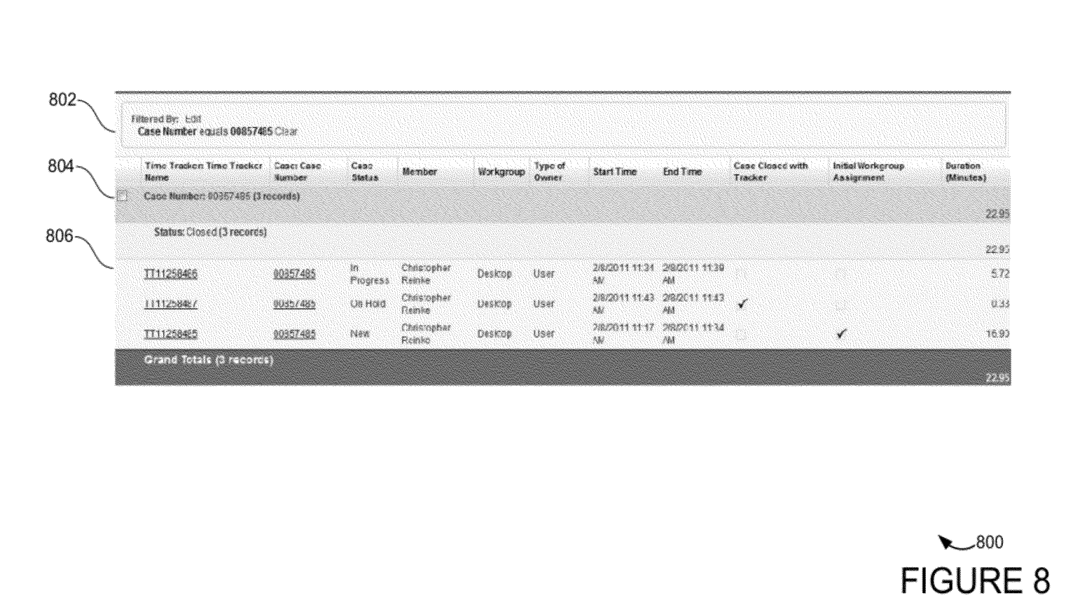

FIG. 8 is an example of an image 800 of a user interface displaying multiple time tracking data objects generated in accordance with one embodiment of process 300 and filtered according to a case identification number. The simultaneous display of multiple time tracking data objects may provide additional information about a record. For example, an image displaying information from multiple time tracking data objects may provide a detailed history of a case. As illustrated in FIG. 8, image 800 may include data fields 802, 804, and 806.

Data field 802 may display information regarding a specific case. In some implementations, data field 802 may display certain filtering preferences that a user may select in order to modify the way in which the time tracking data objects are displayed in image 800. For example, the user may choose to filter the displayed time tracking data objects based on which case the time tracking data object is associated with. When a case-specific filter is selected, time tracking data objects associated with the case may be displayed. In various implementations, multiple case-specific filters may be selected simultaneously. Accordingly, the case history of multiple cases represented by time tracking data objects associated with each case may be viewed simultaneously in image 800. Data field 802 may also display the case identification number associated with the case currently being viewed.

Data field 804 may display information regarding the identity of a case, the history of which is currently being displayed. As illustrated in FIG. 8, image 800 is displaying the case history of case number 00857485. Data field 804 may also display the current status of the case.

Data field 806 may display several time tracking data objects associated with the specified case. The time tracking data objects may display subsets of information associated with a record over a period of time. For example, one time tracking data object in data field 806 may display changes in the status of the case that have occurred after the creation of the case. Another time tracking data object identified in data field 806 may display changes in ownership, transfers to different workgroups, the initial workgroup assignment of the case, and whether or not a case has been closed with a particular time tracking data object. Accordingly, multiple time tracking data objects associated with a case may be displayed to provide a comprehensive history of the case.

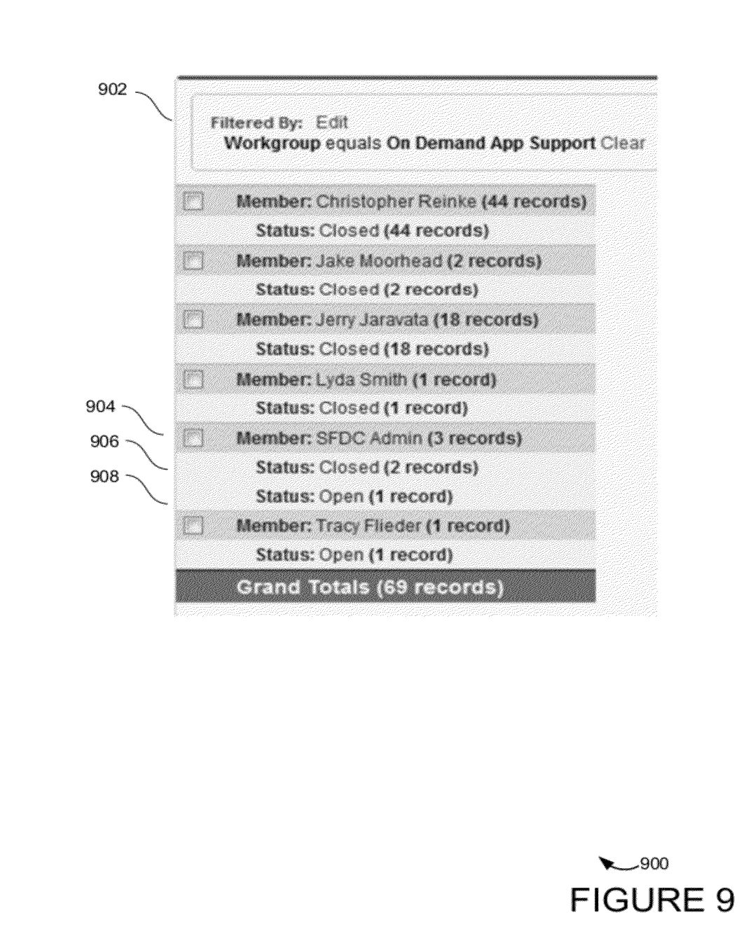

FIG. 9 is an example of an image 900 of a user interface displaying multiple time tracking data objects generated in accordance with one embodiment of process 300 and filtered according to workgroup. As explained above with respect to data field 802, multiple time tracking data objects may be displayed simultaneously and filtered according to a specified user preference. As illustrated in FIG. 9, a user may filter the displayed information based on a specific workgroup. Accordingly, image 900 may include data fields 902, 904, 906, and 908.

Data field 902 may indicate that the time tracking data objects are being filtered by a specified workgroup. Data field 902 may further indicate the identity of the workgroup being displayed. For example, data field 902 may indicate that time tracking data objects for the workgroup “On Demand App Support” are being displayed. When such a filter is applied, only time tracking data objects associated with the workgroup “On Demand App Support” are displayed in image 900.

Data field 904 may organize and display information represented by the time tracking data objects. For example, data field 904 may display all workgroup members associated with the time tracking data objects of a particular workgroup. Data field 904 may include data field 906 that indicates how many records associated with each workgroup member have an open status. Data field 904 may also include data field 908 that indicates how many records associated with each workgroup member have a closed status. Data fields 906 and 908 may display a detailed history of each record, or lead to a separate image displaying a detailed history of each record.

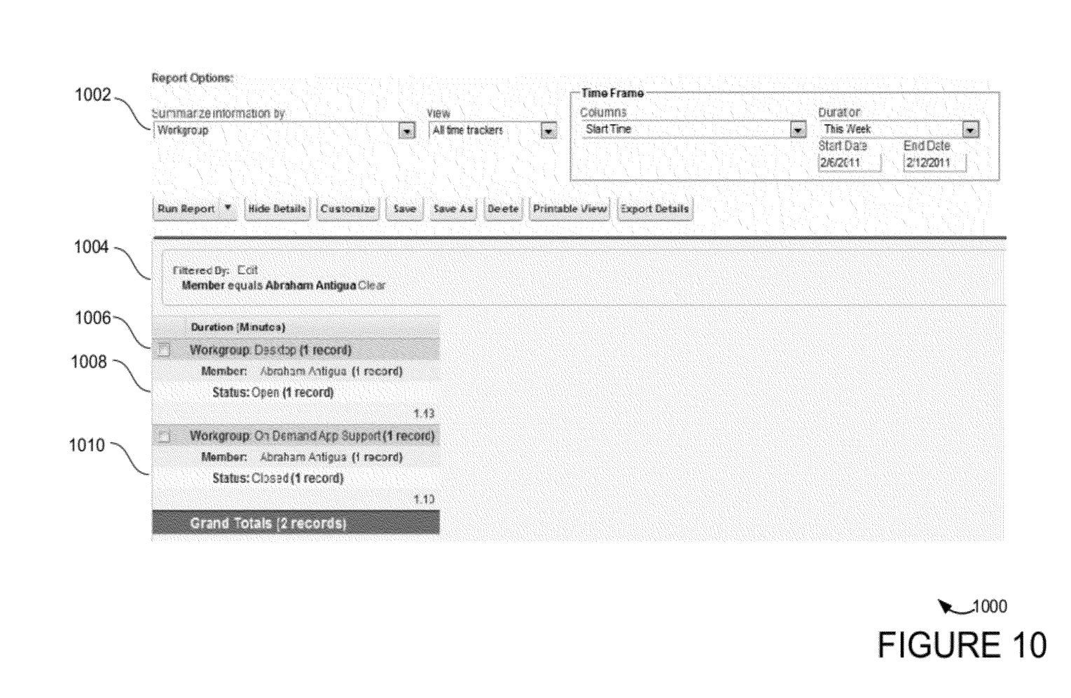

FIG. 10 is an example of an image 1000 of a user interface displaying multiple time tracking data objects generated in accordance with one embodiment of process 300 and filtered according to workgroup member. As explained above with respect to data field 802, multiple time tracking data objects may be displayed simultaneously and filtered according to a specified user preference. As illustrated in FIG. 10, a user may filter the displayed information based on a specific workgroup member. Accordingly, image 1000 may include data fields 1002, 1004, 1006, 1008, and 1010.

Data field 1002 may display information regarding a specific filter or filters being applied to the time tracking data objects. For example, a user may modify the values of data field 1002 to indicate that time tracking data objects associated with a specific workgroup member are sorted by workgroup when displayed in image 1000. The values of data field 1002 may also be modified to filter the time tracking data objects based on time. For example, a user may modify the values of data field 1002 to specify a certain period of time and duration associated with a time tracking data object. If this filter is applied, only time tracking data objects that were active in a certain period of time and for a minimum duration of time will be displayed in image 1000.

Data field 1004 may display information regarding a specific workgroup member that has been selected. For example, data field 1004 may indicate that the time tracking data objects are being filtered by workgroup member. Data field 1004 may further indicate the identity of the workgroup member used as the basis of the filter. For example, data field 1004 may indicate that only time tracking data objects for the workgroup member “Abraham Antigua” are being displayed.

Data field 1006 may organize and display information represented by the filtered time tracking data objects. For example, data field 1006 may display all workgroups associated with the time tracking data objects of a particular workgroup member. Data field 1006 may include data field 1008 that indicates how many records associated with the workgroup member have an open status. Data field 1006 may also include data field 1010 that indicates how many records associated with the workgroup member have a closed status. Data fields 1008 and 1010 may display a detailed history of each record, or lead to a separate image displaying a detailed history of each record.

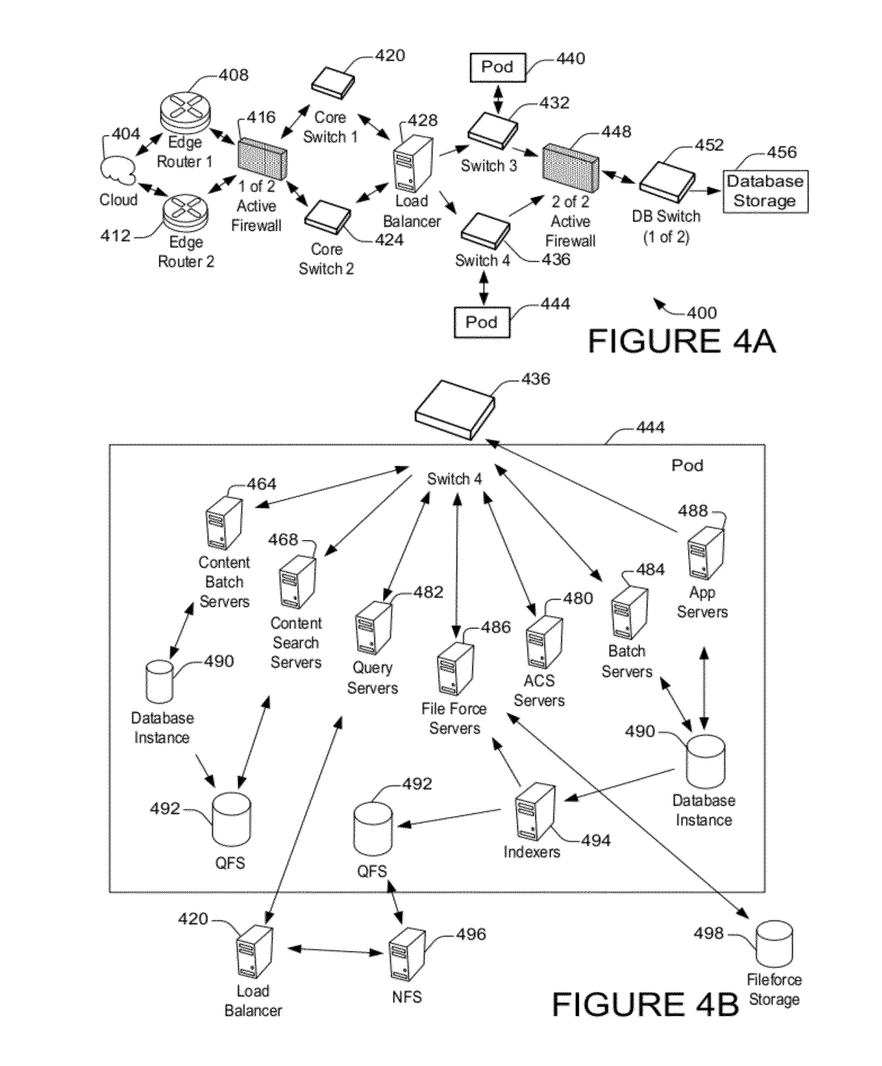

FIG. 4A shows a system diagram 400 illustrating architectural components of an on-demand service environment, in accordance with one embodiment.

A client machine located in the cloud 404 (or Internet) may communicate with the on-demand service environment via one or more edge routers 408 and 412. The edge routers may communicate with one or more core switches 420 and 424 via firewall 416. The core switches may communicate with a load balancer 428, which may distribute server load over different pods, such as the pods 440 and 444. The pods 440 and 444, which may each include one or more servers and/or other computing resources, may perform data processing and other operations used to provide on-demand services. Communication with the pods may be conducted via pod switches 432 and 436. Components of the on-demand service environment may communicate with a database storage system 456 via a database firewall 448 and a database switch 452.

As shown in FIGS. 4A and 4B, accessing an on-demand service environment may involve communications transmitted among a variety of different hardware and/or software components. Further, the on-demand service environment 400 is a simplified representation of an actual on-demand service environment. For example, while only one or two devices of each type are shown in FIGS. 4A and 4B, some embodiments of an on-demand service environment may include anywhere from one to many devices of each type. Also, the on-demand service environment need not include each device shown in FIGS. 4A and 4B, or may include additional devices not shown in FIGS. 4A and 4B.

Moreover, one or more of the devices in the on-demand service environment 400 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 404 is intended to refer to a data network or plurality of data networks, often including the Internet. Client machines located in the cloud 404 may communicate with the on-demand service environment to access services provided by the on-demand service environment. For example, client machines may access the on-demand service environment to retrieve, store, edit, and/or process information.

In some embodiments, the edge routers 408 and 412 route packets between the cloud 404 and other components of the on-demand service environment 400. The edge routers 408 and 412 may employ the Border Gateway Protocol (BGP). The BGP is the core routing protocol of the Internet. The edge routers 408 and 412 may maintain a table of IP networks or ‘prefixes’ which designate network reachability among autonomous systems on the Internet.

In one or more embodiments, the firewall 416 may protect the inner components of the on-demand service environment 400 from Internet traffic. The firewall 416 may block, permit, or deny access to the inner components of the on-demand service environment 400 based upon a set of rules and other criteria. The firewall 416 may act as one or more of a packet filter, an application gateway, a stateful filter, a proxy server, or any other type of firewall.

In some embodiments, the core switches 420 and 424 are high-capacity switches that transfer packets within the on-demand service environment 400. The core switches 420 and 424 may be configured as network bridges that quickly route data between different components within the on-demand service environment. In some embodiments, the use of two or more core switches 420 and 424 may provide redundancy and/or reduced latency.

In some embodiments, the pods 440 and 444 may perform the core data processing and service functions provided by the on-demand service environment. Each pod may include various types of hardware and/or software computing resources. An example of the pod architecture is discussed in greater detail with reference to FIG. 4B.

In some embodiments, communication between the pods 440 and 444 may be conducted via the pod switches 432 and 436. The pod switches 432 and 436 may facilitate communication between the pods 440 and 444 and client machines located in the cloud 404, for example via core switches 420 and 424. Also, the pod switches 432 and 436 may facilitate communication between the pods 440 and 444 and the database storage 456.

In some embodiments, the load balancer 428 may distribute workload between the pods 440 and 444. Balancing the on-demand service requests between the pods may assist in improving the use of resources, increasing throughput, reducing response times, and/or reducing overhead. The load balancer 428 may include multilayer switches to analyze and forward traffic.

In some embodiments, access to the database storage 456 may be guarded by a database firewall 448. The database firewall 448 may act as a computer application firewall operating at the database application layer of a protocol stack. The database firewall 448 may protect the database storage 456 from application attacks such as structure query language (SQL) injection, database rootkits, and unauthorized information disclosure.

In some embodiments, the database firewall 448 may include a host using one or more forms of reverse proxy services to proxy traffic before passing it to a gateway router. The database firewall 448 may inspect the contents of database traffic and block certain content or database requests. The database firewall 448 may work on the SQL application level atop the TCP/IP stack, managing applications' connection to the database or SQL management interfaces as well as intercepting and enforcing packets traveling to or from a database network or application interface.

In some embodiments, communication with the database storage system 456 may be conducted via the database switch 452. The multi-tenant database system 456 may include more than one hardware and/or software components for handling database queries. Accordingly, the database switch 452 may direct database queries transmitted by other components of the on-demand service environment (e.g., the pods 440 and 444) to the correct components within the database storage system 456.

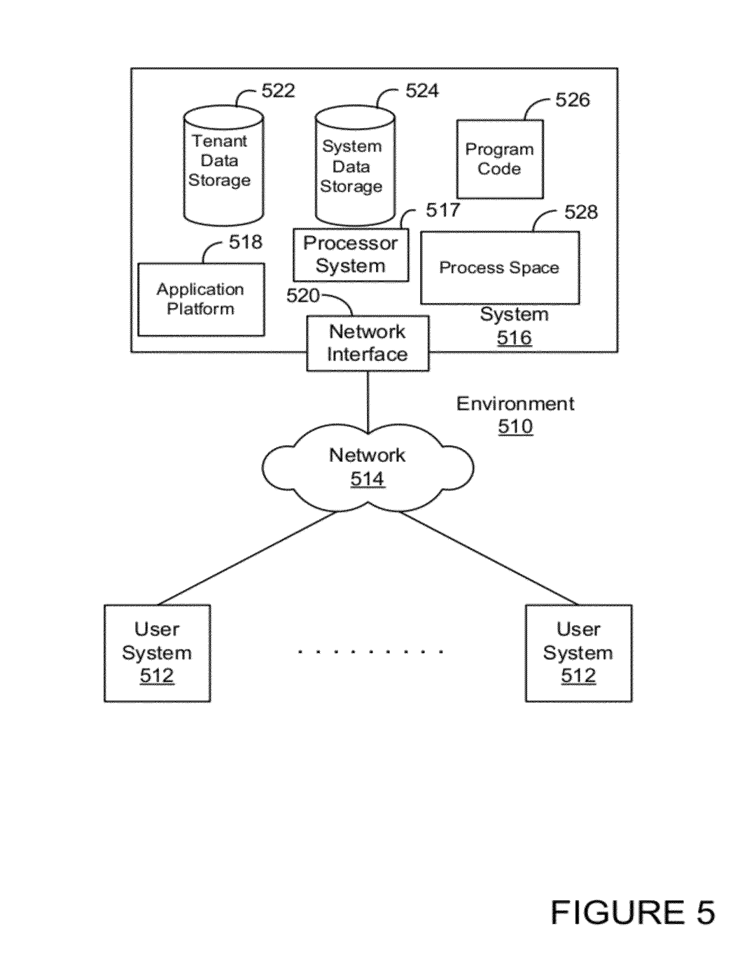

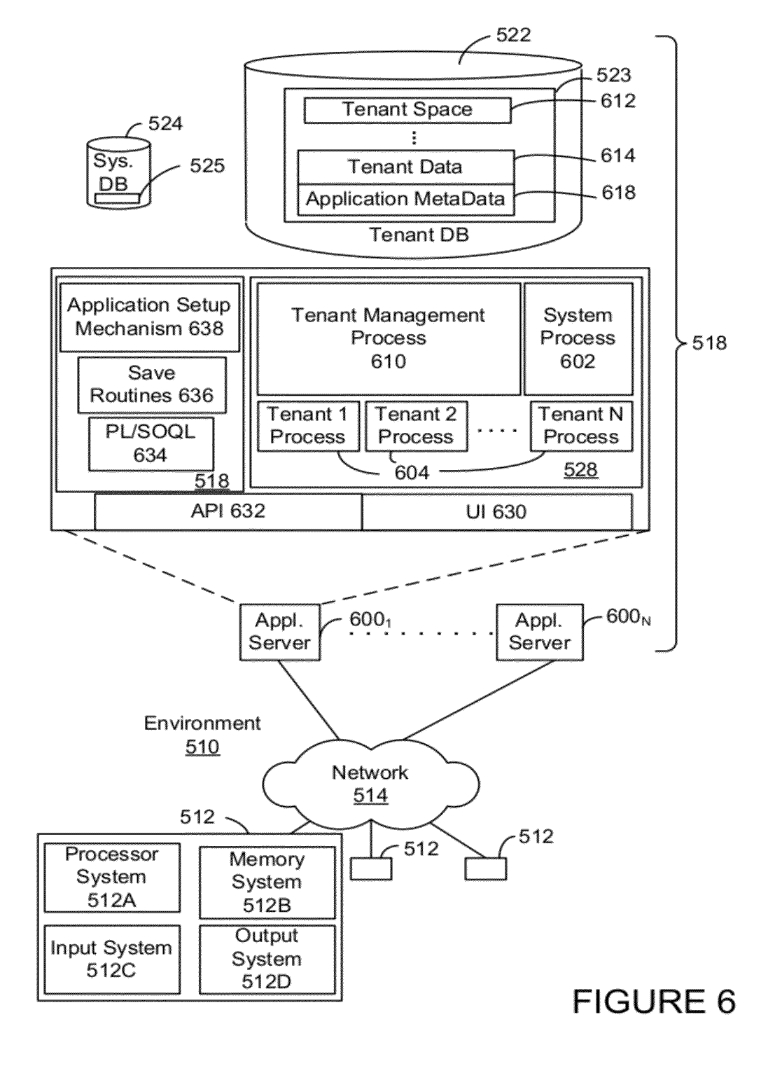

In some embodiments, the database storage system 456 is an on-demand database system shared by many different organizations. The on-demand database system may employ a multi-tenant approach, a virtualized approach, or any other type of database approach. An on-demand database system is discussed in greater detail with reference to FIGS. 5 and 6.

FIG. 4B shows a system diagram illustrating the architecture of the pod 444, in accordance with one embodiment. The pod 444 may be used to render services to a user of the on-demand service environment 400.

In some embodiments, each pod may include a variety of servers and/or other systems. The pod 444 includes one or more content batch servers 464, content search servers 468, query servers 472, file force servers 476, access control system (ACS) servers 480, batch servers 484, and app servers 488. Also, the pod 444 includes database instances 490, quick file systems (QFS) 492, and indexers 494. In one or more embodiments, some or all communication between the servers in the pod 444 may be transmitted via the switch 436.

In some embodiments, the application servers 488 may include a hardware and/or software framework dedicated to the execution of procedures (e.g., programs, routines, scripts) for supporting the construction of applications provided by the on-demand service environment 400 via the pod 444. Some such procedures may include operations for providing the services described herein, for instance, the methods and techniques described above with respect to FIGS. 1-3 and 7-10.

The content batch servers 464 may requests internal to the pod. These requests may be long-running and/or not tied to a particular customer. For example, the content batch servers 464 may handle requests related to log mining, cleanup work, and maintenance tasks.

The content search servers 468 may provide query and indexer functions. For example, the functions provided by the content search servers 468 may allow users to search through content stored in the on-demand service environment.

The Fileforce servers 476 may manage requests information stored in the Fileforce storage 478. The Fileforce storage 478 may store information such as documents, images, and basic large objects (BLOBs). By managing requests for information using the Fileforce servers 476, the image footprint on the database may be reduced.

The query servers 472 may be used to retrieve information from one or more file systems. For example, the query system 472 may receive requests for information from the app servers 488 and then transmit information queries to the NFS 496 located outside the pod.

The pod 444 may share a database instance 490 configured as a multi-tenant environment in which different organizations share access to the same database. Additionally, services rendered by the pod 444 may require various hardware and/or software resources. In some embodiments, the ACS servers 480 may control access to data, hardware resources, or software resources.

In some embodiments, the batch servers 484 may process batch jobs, which are used to run tasks at specified times. Thus, the batch servers 484 may transmit instructions to other servers, such as the app servers 488, to trigger the batch jobs.

In some embodiments, the QFS 492 may be an open source file system available from Sun Microsystems® of Santa Clara, Calif. The QFS may serve as a rapid-access file system for storing and accessing information available within the pod 444. The QFS 492 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 468 and/or indexers 494 to identify, retrieve, move, and/or update data stored in the network file systems 496 and/or other storage systems.

In some embodiments, one or more query servers 472 may communicate with the NFS 496 to retrieve and/or update information stored outside of the pod 444. The NFS 496 may allow servers located in the pod 444 to access information to access files over a network in a manner similar to how local storage is accessed.

In some embodiments, queries from the query servers 422 may be transmitted to the NFS 496 via the load balancer 420, which may distribute resource requests over various resources available in the on-demand service environment. The NFS 496 may also communicate with the QFS 492 to update the information stored on the NFS 496 and/or to provide information to the QFS 492 for use by servers located within the pod 444.

In some embodiments, the pod may include one or more database instances 490. The database instance 490 may transmit information to the QFS 492. When information is transmitted to the QFS, it may be available for use by servers within the pod 444 without requiring an additional database call.

In some embodiments, database information may be transmitted to the indexer 494. Indexer 494 may provide an index of information available in the database 490 and/or QFS 492. The index information may be provided to file force servers 476 and/or the QFS 492.

FIG. 5 shows a block diagram of an environment 510 wherein an on-demand database service might be used, in accordance with one embodiment.

Environment 510 includes an on-demand database service 516. User system 512 may be any machine or system that is used by a user to access a database user system. For example, any of user systems 512 can be a handheld computing device, a mobile phone, a laptop computer, a work station, and/or a network of computing devices. As illustrated in FIGS. 5 and 6, user systems 512 might interact via a network 514 with the on-demand database service 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS).

Accordingly, “on-demand database service 516” and “system 516” will be used interchangeably herein. A database image may include one or more database objects. A relational database management system (RDBMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

The users of user systems 512 may differ in their respective capacities, and the capacity of a particular user system 512 might be entirely determined by permissions (permission levels) for the current user. For example, where a call center agent is using a particular user system 512 to interact with system 516, the user system 512 has the capacities allotted to that call center agent. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some embodiments are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, web pages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications. User (or third party developer) applications, which may or may not include CRM, may be supported by the application platform 518, which manages creation, storage of the applications into one or more database objects and executing of the applications in a virtual machine in the process space of the system 516.

Each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514.

Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application(s) including computer code to run using a central processing unit such as processor system 517, which may include an Intel Pentium® processor or the like, and/or multiple processor units.

A computer program product embodiment includes a machine-readable storage medium (media) having instructions stored thereon/in which can be used to program a computer to perform any of the processes of the embodiments described herein. Computer code for operating and configuring system 516 to intercommunicate and to process web pages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for implementing embodiments can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to one embodiment, each system 516 is configured to provide web pages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also shows a block diagram of environment 510 further illustrating system 516 and various interconnections, in accordance with one embodiment. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 6001-600N, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of processors. Memory system 512B may be any combination of one or more memory devices, short term, and/or long term memory. Input system 512C may be any combination of input devices, such as keyboards, mice, trackballs, scanners, cameras, and/or interfaces to networks. Output system 512D may be any combination of output devices, such as monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as Oracle™ databases.

Application platform 518 includes an application setup mechanism 638 that supports application developers' creation and management of applications, which may be saved as metadata into tenant data storage 522 by save routines 636 for execution by subscribers as tenant process spaces 604 managed by tenant management process 610 for example. Invocations to such applications may be coded using PL/SOQL 34 that provides a programming language style interface extension to API 632. A detailed description of some PL/SOQL language embodiments is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 6001 might be coupled via the network 514 (e.g., the Internet), another application server 600N-1 might be coupled via a direct network link, and another application server 600N might be coupled by yet a different network connection. Transfer Control Protocol and Internet Protocol (TCP/IP) are typical protocols for communicating between application servers 600 and the database system. However, other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each call center agent uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client machines/systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some embodiments. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some embodiments, for example, all custom entity data rows are stored in a single multi-tenant physical table, which may contain multiple logical tables per organization. In some embodiments, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-readable media that include program instructions, state information, etc., for performing various operations described herein. Examples of program instructions include both machine code, such as produced by a compiler, and files containing higher-level code that may be executed by the computer using an interpreter.

Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to an embodiment in which a service cloud console is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2®, by IBM and the like without departing from the scope of the embodiments claimed.

Any of the above embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While various embodiments have been described herein, it should be understood that they have been presented by way of example only, and not limitation. Thus, the breadth and scope of the present application should not be limited by any of the embodiments described herein, but should be defined only in accordance with the following and later-submitted claims and their equivalents.

What is claimed is:

1. A method comprising:
determining that an attribute of a record in a database has changed;
determining whether the record has an open status or a closed status;
when the record has the open status, determining whether an owner of the record is a member of a designated workgroup; and
when the owner is a member of the designated workgroup, creating a time tracking data object associated with the record, the time tracking data object including a plurality of fields storing information indicating one or more attributes of the record, the fields including a start time field indicating a start time of the time tracking data object, a duration field indicating a duration of the time tracking data object, and a status field indicating a status of the time tracking data object.

2. The method of claim 1, the changed attribute being an indication of the owner of the record.

3. The method of claim 1, the changed attribute being an indication of a status of the record.

4. The method of claim 3, the changed attribute being an indication that the record does not have the closed status.

5. The method of claim 1, the determining that the attribute of the record has changed being performed responsive to saving the record to the database.

6. The method of claim 1, the one or more attributes being selected from the group consisting of: a case number, a case ID, a member name, a member ID, a member's workgroup, a type of owner, and an initial workgroup assignment.

7. The method of claim 1, the record being a case.

8. The method of claim 7, one or more further time tracking data objects being associated with the case, the one or more further time tracking data objects each including a plurality of fields storing information indicating a creation time, a transfer time, and status of the case.

9. The method of claim 8, the status having an open status, a closed status, an on-hold status, or an active status.

10. The method of claim 1, further comprising:
determining whether one or more further time tracking data objects associated with the record have an open status; and
when the one or more further time tracking data objects have the open status, updating a status field of the one or more further time tracking data objects to indicate a closed status.

11. The method of claim 1, further comprising:
receiving a message indicating that the owner of the record is a member of the designated workgroup.

12. The method of claim 1, further comprising:
receiving a message indicating that the owner of the record is not a member of the designated workgroup.

13. The method of claim 12, further comprising:
responsive to receiving the message; determining whether one or more time tracking data objects associated with the record have an open status; and
when the one or more time tracking data objects have the open status, updating a status field of the one or more further time tracking data objects to indicate a closed status.

14. The method of claim 1, further comprising:
receiving a message indicating that the record has been deleted;
responsive to receiving the message; determining whether one or more time tracking data objects are associated with the record; and
when one or more time tracking data objects are associated with the record, updating one or more of the fields storing information indicating attributes of the record.

15. The method of claim 14, the updated one or more fields including the status field indicating that the record has a deleted status.

16. The method of claim 14, the updated one or more fields including an ID field identifying the record.

17. A system comprising:
a database system;
one or more servers configured to:
determine that an attribute of a record in the database system has changed;
determine whether the record has an open status or a closed status;
when the record has the open status, determine whether an owner of the record is a member of a designated workgroup; and
when the owner is a member of the designated workgroup, create a time tracking data object associated with the record, the time tracking data object including a plurality of fields storing information indicating attributes of the record, the fields including a start time field indicating a start time of the time tracking data object, a duration field indicating a duration of the time tracking data object, and a status field indicating a status of the time tracking data object.

18. The system of claim 17, further comprising:
determining whether one or more further time tracking data objects associated with the record have an open status; and
when the one or more further time tracking data objects have the open status, updating a status field of the one or more further time tracking data objects to indicate a closed status.

19. The system of claim 17, further comprising:
receiving a message indicating that the owner of the record is a member of the designated workgroup.

20. The system of claim 17, further comprising:
receiving a message indicating that the owner of the record is not a member of the designated workgroup.

21. The system of claim 17, further comprising:
receiving a message indicating that the record has been deleted;
responsive to receiving the message; determining whether one or more time tracking data objects are associated with the record; and
when one or more time tracking data objects are associated with the record, updating one or more of the fields storing information indicating attributes of the record.

22. The system of claim 17, the record being a case and one or more further time tracking data objects being associated with the case, the one or more further time tracking data objects each including a plurality of fields storing information indicating a creation time, a transfer time, and status of the case.

23. The system of claim 17, the record referring to at least one second record such that the time tracking data object includes a plurality of fields storing information indicating attributes of the record and the at least one second record.

24. The system of claim 17, the database system being a component of a multi-tenant database in an on-demand service environment.

25. One or more computer readable media having instructions stored thereon for performing a method, the method comprising:
determining that an attribute of a record in a database has changed;
determining whether the record has an open status or a closed status;
when the record has the open status, determining whether an owner of the record is a member of a designated workgroup; and
when the owner is a member of the designated workgroup, creating a time tracking data object associated with the record, the time tracking data object including a plurality of fields storing information indicating attributes of the record, the fields including a start time field indicating a start time of the time tracking data object, a duration field indicating a duration of the time tracking data object, and a status field indicating a status of the time tracking data object.

26. The one or more computer readable media of claim 25, the instructions further comprising:
determining whether one or more further time tracking data objects associated with the record have an open status; and
when the one or more further time tracking data objects have the open status, updating a status field of the one or more further time tracking data objects to indicate a closed status.

27. The one or more computer readable media of claim 25, the instructions further comprising:
receiving a message indicating that the owner of the record is a member of the designated workgroup.

28. The one or more computer readable media of claim 25, the instructions further comprising:
receiving a message indicating that the owner of the record is not a member of the designated workgroup.

29. The one or more computer readable media of claim 25, the instructions further comprising:
receiving a message indicating that the record has been deleted;
responsive to receiving the message; determining whether one or more time tracking data objects are associated with the record; and
when one or more time tracking data objects are associated with the record, updating one or more of the fields storing information indicating attributes of the record.

30. The one or more computer readable media of claim 25, the record being a case and one or more further time tracking data objects being associated with the case, the one or more further time tracking data objects each including a plurality of fields storing information indicating a creation time, a transfer time, and status of the case.
